(19) United States
(12) Patent Application Publication
(10) Pub. No.: US 2025/0017210 A1
(43) Pub. Date: Jan. 16, 2025

(54) PESTICIDAL COMPOSITIONS

(71) Applicant: SYNGENTA CROP PROTECTION AG, Basel (CH)

(72) Inventors: Gemma HALLAM-BARNES, Bracknell, Berkshire (GB); Francesca Jain FALLUTO, Bracknell, Berkshire (GB)

(73) Assignee: SYNGENTA CROP PROTECTION AG, Basel (CH)

(21) Appl. No.: 18/712,964

(22) PCT Filed: Nov. 18, 2022
(86) PCT No.: PCT/EP2022/082474

§ 371 Date: May 23, 2024

(30) Foreign Application Priority Data
Nov. 25, 2021 (EP) 21210434.3

(51) Int. Cl. A01N 43/90; A01N 25/04; A01N 25/10; A01N 47/06; A01P 7/00

(52) U.S. Cl. CPC A01N 43/90; A01N 25/04; A01N 25/10; A01N 47/06; A01P 7/00

(57) ABSTRACT

PESTICIDAL COMPOSITIONA pesticidal composition comprising: 5 (i) 5 to 15% by weight of spiropidion; (ii) 1 to 5% by weight of abamectin: and (iii) 1 to 5% by weight of a dispersing agent comprising an acrylic graft copolymer solution in water and propylene glycol.0

The present invention relates to a composition comprising a combination of insecticidal active ingredients, to the preparation of such compositions, and to a method of using such a composition to control pests in crops of useful plants.

Insecticidal compositions containing combinations of the insecticidal active ingredient spiropidion with another active ingredient are known, eg, from WO 2013/079564. In certain compositions for use in insect control on crop plants, the stability of the composition when formulated may be adversely affected by exposure of the formulation to temperature variations (low or high) when in use or when in storage prior to use. Clearly, such formulation stability is critical to the viability and performance of the composition for insecticidal use. Accordingly, there remains a strong motivation to develop insecticidal compositions where for practical purposes the composition (eg, a suspension concentrate formulation) retains stability over a range of temperatures for prolonged periods.

According to the present invention, there is provided a pesticidal composition comprising:
(i) 5 to 15% by weight of spiropidion;
(ii) 1 to 5% by weight of abamectin; and
(iii) 1 to 5% by weight of a dispersing agent comprising an acrylic graft copolymer solution in water and propylene glycol.

As is known in the art, pesticidal compositions comprising spiriopidion and abamectin have, for practical purposes, a very advantageous level of activity in controlling insect pests in crops of useful plants after foliar or soil application, whilst also maintaining acceptable crop safety (phytotoxicity) outcomes once applied to a crop at a suitable dilution. By activity, it is meant that these compositions are capable of killing or controlling insects, retarding the growth or reproduction of insects, reducing an insect population, and/or reducing damage to plants caused by insects.

Surprisingly, it has been found that the inclusion of a dispersant system comprising an acrylic graft copolymer in compositions (formulations) comprising spiropidion and abamectin as active ingredients significantly improves the formulation stability at varying temperatures. This stabilisation may include the prevention of flocculation of the solid components at low temperature (−10/10° C. cycling) and crystal growth affecting particle distribution at higher temperatures (40° C.) than may be observed when other dispersing agents known in the art are used. Such low and high temperatures may be indicative of storage conditions for such agrochemical formulations.

Further according to the invention, there is provided an aqueous composition comprising the pesticidal composition according the invention, optionally further comprising one or more adjuvants or carriers.

Still further according to the invention, there is provided a (non-therapeutic) method of combating and controlling pests which comprises applying to a pest, to a locus of a pest, or to a crop of a useful plant susceptible to attack by a pest a composition according to the invention.

Spiropidion ([3-(4-chloro-2,6-dimethyl-phenyl)-8-methoxy-1-methyl-2-oxo-1,8-diazaspiro[4.5] dec-3-en-4-yl] ethyl carbonate. CAS no.: 1229023-00-0) is known inter alia from WO 2010/066780, WO 2018/114648 and WO 2018/114649. Abamectin (avermectin B1. CAS no.: 71751-41-2) is known inter alia from U.S. Pat. No. 4,310,519. Certain pesticidal mixtures comprising spiropidion and abamectin as active ingredients are known from WO 2013/079564.

Preferably, the composition according to the present invention is a suspension concentrate (SC), which is a stable suspension of a solid pesticidal active ingredient compound or mixture of compounds in a liquid, usually intended for dilution with water (in a spray tank or other vessel) before use. The compositions of the present invention may be made up to 100% by weight with the addition of water.

A dispersant or a dispersing agent is typically a surfactant substance, which when added to a suspension of solid particles in a liquid better enables the separation of the particles to avoid their settling or clumping together.

The dispersing agent used in combination in accordance with the present invention may comprise an acrylic graft copolymer which is a 2-methyl-2-propenoic acid and methyl 2-methyl-2-propenoate polymer with α-methyl-Ω-hydroxypoly (oxy-1,2-ethanediyl) graft. In certain embodiments, this may be otherwise defined as a methyl methacrylate/methacrylic acid/monomethoxypolyethylene glycol (PEG) methacrylate graft copolymer (eg, Atlox™ 4913, Uniqema Surfactants Ltd, UK). Such surfactant component may have a minimum number average molecular weight of 2,500 to 3000 Da, and preferably 2,650 to 2,800 Da.

Preferably, the dispersing agent (acrylic graft copolymer solution) has a hydrophilic-lipophilic balance (HLB) of 11 to 13.

Preferably, at 20° C., the dispersing agent (acrylic graft copolymer solution) used in accordance with the invention has a density of 1.0 to 1.2 g/mL of the solution, more preferably 1.05 to 1.15 g/mL, and even more preferably, 1.05 to 1.10 g/mL.

Preferably, the dispersing agent (acrylic graft copolymer solution) is present at 2 to 4% by weight of the total composition according to the invention.

Preferably, the compositions according to the invention comprise as the pesticidal active ingredient component (i) 8 to 10% by weight of spiropidion and (ii) 1 to 2% by weight of abamectin of the total composition. The compositions according to the invention comprise as the pesticidal active ingredient component spiropidion and abamectin, respectively, preferably in a weight ratio of 7:1 to 5:1, and more preferably, 7:1 to 6:1.

Preferably, in an aqueous composition according to the invention (eg, a tank mix preparation for applying to a crop), the adjuvant is selected from a mineral oil, a vegetable oil, an esterified vegetable oil, a methylated vegetable oil or an alkyl ester phosphate-based adjuvant. A pesticide adjuvant may be defined as a substance present in a pesticidal composition (eg, a concentrated active ingredient formulation diluted in water in a tank for a foliar spray application on a crop), which improves pesticidal active ingredient performance, for example by facilitating the spreading of the active ingredient on a leaf surface or penetration into the leaf of the crop plant.

Examples of adjuvant classes, which may be used in accordance with the present invention include a mineral oil, a vegetable oil, an esterified vegetable oil, a methylated vegetable oil or an alkyl ester phosphate-based adjuvant. Commercially-available adjuvant products which may be tank-mixed to yield a spray fomulation with the composition of the present invention include HASTEN™ (Victorian Chemical Co. Pty. Ltd.—blend of an esterified vegetable oil and non-ionic surfactants), OCHIMAR (Syngenta—alkyl ester of phosphoric acid (EC formulation)), LEDNA™ (Polaquimia—EC formulation comprising a methyl ester of soybean oil), Atplus® 463 (CRODA Europe Limited—60% parafin oil with surfactant blend), Actirob® B (Bayer AG—rapeseed oil methyl ester (esterified vegetable oil)), Destiny® HC (Winfield Solutions LLC—methylated soybean oil), DYNE-AMIC® (HELENA—blend of (methylated) vegetable oil and organosilicone-based nonionic surfactants), and FS Optique™ (GROWMARK, Inc—methyl ester of canola oil).

Dispersing agents which may additionally be used in accordance with the present invention include, but are not limited to, lignosulphonate salts (eg, Ufoxane 3A, Borregard AS; Borresperse NA, Borregard AS; Polyfon™ H, Ingevity; Marasperse CBOS-4 powder, LignoTech), naphthalene sulfonic acid salts (eg, Dispergator B Gran, TFL Ledertechnik GmbH), a co-polymer of 2,5-furandione and 2,4,4-trimethylpentene (eg, Geropon® Ta/72, Solvay), sodium alkyl naphthalene sulfonate formaldehyde condensate (eg, Morwet D-425, Nouryon Surface Chemistry AB, Sweden. CAS no.: 9084-06-4 ((C₁₀H₈O₃S·CH₂O)ₙ·xNa)). In a preferred embodiment of the invention, a further dispersing agent may be 0.2 to 1.0% by weight, and preferably, 0.2 to 0.5% by weight, of a sodium alkyl naphthalene sulfonate formaldehyde condensate, eg, Morwet D-425.

An anti-foaming agent is a chemical additive that reduces and hinders the formation of foam in a composition, such as a pesticidal formulation. Anti-foaming agents which may be used in accordance with the present invention include, but are not limited to, polydimethylsiloxanes (eg, XIAMETER™ ACP-1500, Dow, Inc; Antifoam MSA, Univar; Xiameter ACP-0001, Dow Brasil; Xiameter ACP-0100, Dow Chemical).

Preferably, the compositions according to the invention comprise 0.1 to 2% by weight of a buffering agent. Preferably, the buffering agent is an organic acid that contains 1, 2 or 3 carboxylic acid groups. More preferably, the organic acid is a tricarboxylic acid (ie, contains three carboxylic acid groups) such as citric acid, or a sodium or potassium salt thereof.

Preferably, the compositions according to the invention comprise 5 to 10% by weight of 1,2-propylene glycol, and more preferably, 7 to 8% by weight of 1,2-propylene glycol.

Preferably, the compositions according to the invention comprise 0.1 to 2% by weight of a thickening agent, which may be selected from a natural gum substance, such as guar gum or xanthan gum, or a montmorillonite-type clay (eg, Bentopharm™ 20, Wilfrid Smith, UK).

Examples of pests which may be controlled in accordance with the compositions of the present invention include those:
from the order Acarina, for example, Acalitus spp, Aculus spp, Acaricalus spp, Aceria spp, Acarus siro, Amblyomma spp., Argas spp., Boophilus spp., Brevipalpus spp., Bryobia spp, Calipitrimerus spp., Chorioptes spp., Dermanyssus gallinae, Dermatophagoides spp, Eotetranychus spp, Eriophyes spp., Hemitarsonemus spp, Hyalomma spp., Ixodes spp., Olygonychus spp, Omithodoros spp., Polyphagotarsone latus, Panonychus spp., Phyllocoptruta oleivora, Phytonemus spp, Polypha-gotarsonemus spp, Psoroptes spp., Rhipicephalus spp., Rhizoglyphus spp.,Sarcoptes spp., Steneotarsonemus spp, Tarsonemus spp. and Tetranychus spp.;
from the order Anoplura, for example, Haematopinus spp., Linognathus spp., Pediculus spp., Pemphigus spp. and Phylloxera spp.;
from the order Coleoptera, for example, Agriotes spp., Amphimallon majale, Anomala orientalis, Anthonomus spp., Aphodius spp, Astylus atromaculatus, Ataenius spp, Atomaria linearis, Chaetocnema tibialis, Cerotoma spp, Conoderus spp, Cosmopolites spp., Cotinis nitida, Curculio spp., Cyclocephala spp, Dermestes spp., Diabrotica spp., Diloboderus abderus, Epilachna spp., Eremnus spp., Heteronychus arator, Hypothenemus hampei, Lagria vilosa, Leptinotarsa decemLineata, Lissorhoptrus spp., Liogenys spp, Maecolaspis spp, Maladera castanea, Megascelis spp, Melighetes aeneus, Melolontha spp., Myochrous armatus, Orycaephilus spp., Otiorhynchus spp., Phyllophaga spp, Phlyctinus spp., Popilia spp., Psylliodes spp., Rhyssomatus aubtilis, Rhizopertha spp., Scarabeidae, Sitophilus spp., Sitotroga spp., Somaticus spp, Sphenophorus spp, Sternechus subsignatus, Tenebrio spp., Tribolium spp. and Trogoderma spp.;
from the order Diptera, for example, Aedes spp., Anopheles spp, Antherigona soccata, Bactrocea oleae, Bibio hortulanus, Bradysia spp, Calliphora erythrocephala, Ceratitis spp., Chrysomyia spp., Culex spp., Cuterebra spp., Dacus spp., Delia spp, Drosophila melanogaster, Fannia spp., Gastrophilus spp., Geomyza tripunctata, Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis spp, Rivelia quadrifasciata, Scatella spp, Sciara spp., Stomoxys spp., Tabanus spp., Tannia spp. and Tipula spp.;
from the order Hemiptera, for example, Acanthocoris scabrator, Acrosternum spp, Adelphocoris lineolatus, Amblypelta nitida, Bathycoelia thalassina, Blissus spp, Cimex spp., Clavigralla tomentosicollis, Creontiades spp, Distantiella theobroma, Dichelops furcatus, Dysdercus spp., Edessa spp, Euchistus spp., Eurydema pulchrum, Eurygaster spp., Halyomorpha halys, Horcias nobilellus, Leptocorisa spp., Lygus spp, Margarodes spp, Murgantia histrionic, Neomegalotomus spp, Nesidiocoris tenuis, Nezara spp., Nysius simulans, Oebalus insularis, Piesma spp., Piezodorus spp, Rhodnius spp., Sahlbergella singularis, Scaptocoris castanea, Scotinophara spp., Thyanta spp, Triatoma spp., and Vatiga illudens;
from the order Homoptera, for example, Acyrthosium pisum, Adalges spp, Agalliana ensigera, Agonoscena targionii, Aleurodicus spp, Aleurocanthus spp, Aleurolobus barodensis, Aleurothrixus floccosus, Aleyrodes brassicae, Amarasca biguttula, Amritodus atkinsoni, Aonidiella spp., Aonidiella auranti, Aphididae, Aphis spp., Aspidiotus spp., Aulacorthum solani, Bactericera cockerelli, Bemisia spp, Brachycaudus spp, Brevicoryne brassicae, Cacopsylla spp, Cavariella aegopodii Scop., Ceroplaster spp., Chrysomphalus aonidium, Chrysomphalus dictyospermi, Cicadella spp, Cofana spectra, Cryptomyzus spp, Cicadulina spp, Coccus hesperidum, Dalbulus maidis, Dialeurodes spp, Diaphorina citri, Diuraphis noxia, Dysaphis spp, Empoasca spp., Eriosoma larigerum, Erythroneura spp., Gascardia spp., Glycaspis brimblecombei, Hyadaphis pseudobrassicae, Hyalopterus spp, Hyperomyzus pallidus, Idioscopus clypealis, Jacobiasca lybica, Laodelphax spp., Lecanium corni, Lepidosaphes spp., Lopaphis erysimi, Lyogenys maidis, Macrosiphum spp., Mahanarva spp, Metcalfa pruinosa, Metopolophium dirhodum, Myndus crudus, Myzus spp., Neotoxoptera sp, Nephotettix spp., Nilaparvata spp., Nippolachnus piri Mats, Odonaspis ruthae, Oregma lanigera Zehnter, Parabemisia myricae, Paratrioza cockerelli, Parlatoria spp., Pemphigus spp., Peregrinus maidis, Perkinsiella spp, Phorodon humuli, Phylloxera spp, Planococcus spp., Pseudaulacaspis spp., Pseudococcus spp., Pseudatomoscelis seriatus, Psylla spp., Pulvinaria aethiopica, Quadraspidiotus spp., Quesada gigas, Recilia dorsalis, Rhopalosiphum spp., Saissetia spp., Scaphoideus spp., Schizaphis spp., Sitobion spp., Sogatella furcifera, Spissistilus festinus, Tarophagus Proserpina, Toxoptera spp, Trialeurodes spp, Tridiscus sporoboli, Trionymus spp, Trioza erytreae, Unaspis citri, Zygina flammigera, and Zyginidia scutellaris;
from the order Hymenoptera, for example, Acromyrmex, Arge spp, Atta spp., Cephus spp., Diprion spp., Diprionidae, Gilpinia polytoma, Hoplocampa spp., Lasius spp., Monomorium pharaonis, Neodiprion spp., Pogonomyrmex spp, Slenopsis invicta, Solenopsis spp. and Vespa spp.;
from the order Isoptera, for example, Coptotermes spp, Corniternes cumulans, Incisitermes spp, Macrotermes spp, Mastotermes spp, Microtermes spp, Reticulitermes spp.; Solenopsis geminate;
from the order Lepidoptera, for example, Acleris spp., Adoxophyes spp., Aegeria spp., Agrotis spp., Alabama argillaceae, Amylois spp., Anticarsia gemmatalis, Archips spp., Argyresthia spp, Argyrotaenia spp., Autographa spp., Bucculatrix thurberiella, Busseola fusca, Cadra cautella, Carposina nipponensis, Chilo spp., Choristoneura spp., Chrysoteuchia topiaria, Clysia ambiguella, Cnaphalocrocis spp., Cnephasia spp., Cochylis spp., Coleophora spp., Colias lesbia, Cosmophila flava, Crambus spp, Crocidolomia binotalis, Cryptophlebia leucotreta, Cydalima perspectalis, Cydia spp., Diaphania perspectalis, Diatraea spp., Diparopsis castanea, Earias spp., Eldana saccharina, Ephestia spp., Epinotia spp, Estigmene acrea, Etiella zinckinella, Eucosma spp., Eupoecilia ambiguella, Euproctis spp., Euxoa spp., Feltia jaculiferia, Grapholita spp., Hedya nubiferana, Heliothis spp., Hellula undalis, Herpetogramma spp, Hyphantria cunea, Keiferia lycopersicella, Lasmopalpus lignosellus, Leucoptera scitella, Lithocollethis spp., Lobesia botrana, Loxostege bifidalis, Lymantria spp., Lyonetia spp., Malacosoma spp., Mamestra brassicae, Manduca sexta, Mythimna spp, Noctua spp, Operophtera spp., Omiodes indica, Ostrinia nubilalis, Pammene spp., Pandemis spp., Panolis flammea, Papaipema nebris, Pectinophora gossypiela, Perileucoptera coffeella, Pseudaletia unipuncta, Phthorimaea operculella, Pieris rapae, Pieris spp., Plutella xylostella, Prays spp., Pseudoplusia spp, Rachiplusia nu, Richia albicosta, Scirpophaga spp., Sesamia spp., Sparganothis spp., Spodoptera spp., Sylepta derogate, Synanthedon spp., Thaumetopoea spp., Tortrix spp., Trichoplusia ni, Tuta absoluta, and Yponomeuta spp.;
from the order Mallophaga, for example, Damalinea spp. and Trichodectes spp.;
from the order Orthoptera, for example, Blatta spp., Blattella spp., Gryllotalpa spp., Leucophaea maderae, Locusta spp., Neocurtilla hexadactyla, Periplaneta spp., Scapteriscus spp, and Schistocerca spp.;
from the order Psocoptera, for example, Liposcelis spp.;
from the order Siphonaptera, for example, Ceratophyllus spp., Ctenocephalides spp. and Xenopsylla cheopis;
from the order Thysanoptera, for example, Calliothrips phaseoli, Frankliniella spp., Heliothrips spp, Hercinothrips spp., Parthenothrips spp, Scirtothrips aurantii, Sericothrips variabilis, Taeniothrips spp.,Thrips spp; and/or
from the order Thysanura, for example, Lepisma saccharina.

Examples of soil-inhabiting pests, which can damage a crop in the early stages of plant development, are:
from the order Lepidoptera, for example, Acleris spp., Aegeria spp., Agrotis spp., Alabama argillaceae, Amylois spp., Autographa spp., Busseola fusca, Cadra cautella, Chilo spp., Crocidolomia binotalis, Diatraea spp., Diparopsis castanea, Elasmopalpus spp., Heliothis spp., Mamestra brassicae, Phthorimaea operculella, Plutella xylostella, Scirpophaga spp., Sesamia spp., Spodoptera spp. and Tortrix spp.;
from the order Coleoptera, for example, Agriotes spp., Anthonomus spp., Atomaria linearis, Chaetocnema tibialis, Conotrachelus spp., Cosmopolites spp., Curculio spp., Dermestes spp., Diabrotica spp., Dilopoderus spp., Epilachna spp., Eremnus spp., Heteronychus spp., Lissorhoptrus spp., Melolontha spp., Orycaephilus spp., Otiorhynchus spp., Phlyctinus spp., Popillia spp., Psylliodes spp., Rhizopertha spp., Scarabeidae, Sitotroga spp., Somaticus spp., Tanymecus spp., Tenebrio spp., Tribolium spp., Trogoderma spp. and Zabrus spp.;
from the order Orthoptera, for example, Gryllotalpa spp.;
from the order Isoptera, for example, Reticulitermes spp.;
from the order Psocoptera, for example, Liposcelis spp.;
from the order Anoplura, for example, Haematopinus spp., Linognathus spp., Pediculus spp., Pemphigus spp. andPhylloxera spp.;
from the order Homoptera, for example, Eriosoma larigerum;
from the order Hymenoptera, for example, Acromyrmex, Atta spp., Cephus spp., Lasius spp., Monomorium pharaonis, Neodiprion spp., Solenopsis spp. and Vespa spp.;
from the order Diptera, for example, Tipula spp.;
crucifer flea beetles (Phyllotreta spp.), root maggots (Delia spp.), cabbage seedpod weevil (Ceutorhynchus spp.) and aphids.

In particular, the compositions of the invention may be applied against insects from the order Homoptera (in particular, white flies, aphids, psyllids and armoured and soft scales), Thysanoptera (thrips), Acarina (mites) and Lepidoptera (butterflies and moths, and larva thereof). Preferably, the compositions of the invention may be applied against white flies, mites, aphids, thrips.

Crops of useful plants in which the compositions according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus (oranges, lemons, grapefruit, limes), nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, watermelon, okra, onion, leek, pepper, chili, potato, pumpkin, squash, rhubarb, spinach and tomato; and vines for example grapes. The compositions of the invention can also be applied on turf, lawn and pastures.

Preferably, the compositions of the invention may be applied to a crop of a useful plant selected from:
the order Solanacea (including tomato, potato, aubergine, chilli, pepper, tobacco);
the order Cucurbitaceae (including squash, pumpkin, watermelon, melon, cucumber);
Citrus (including oranges, lemons, grapefruit, limes);
Tea (Camellia sinensis).

Preferably, the composition of the invention may be applied to a crop of a useful plant selected from tea, cucumber, melon, watermelon, citrus, strawberry, eggplant, tomato, pepper, chili, okra.

In an aqueous composition comprising the pesticidal composition according to the invention (eg, a tank-mix composition), there may be added a further component comprising a pesticidal active ingredient selected from one or more of:

Acequinocyl, Acetamiprid, Acetoprole, Acrinathrin, Acynonapyr, Afidopyropen, Afoxalaner, Alanycarb, Allethrin, Alpha-Cypermethrin, Alphamethrin, Amidoflumet, Aminocarb, Azocyclotin, Bensultap, Benzoximate, Benzpyrimoxan, Betacyfluthrin, Beta-cypermethrin, Bifenazate, Bifenthrin, Binapacryl, Bioallethrin, Bioallethrin S)-cyclopentylisomer, Bioresmethrin, Bistrifluron, Broflanilide, Brofluthrinate, Bromophos-ethyl, Buprofezine, Butocarboxim, Cadusafos, Carbaryl, Carbosulfan, Cartap, CAS number: 1472050 Apr. 6, CAS number: 1632218-00-8, CAS number: 1808115-49-2, CAS number: 2032403-97-5, CAS number: 2044701-44-0, CAS number: 2128706 May 6, CAS number: 2249718-27-0, Chlorantraniliprole, Chlordane, Chlorfenapyr, Chloroprallethrin, Chromafenozide, Clenpirin, Cloethocarb, Clothianidin, 2-chlorophenyl N-methylcarbamate (CPMC), Cyanofenphos, Cyantraniliprole, Cyclaniliprole, Cyclobutrifluram, Cycloprothrin, Cycloxaprid, Cycloxaprid, Cyenopyrafen, Cyetpyrafen (or Etpyrafen), Cyflumetofen, Cyfluthrin, Cyhalodiamide, Cyhalothrin, Cypermethrin, Cyphenothrin, Cyproflanilide, Cyromazine, Deltamethrin, Diafenthiuron, Dialifos, Dibrom, Dicloromezotiaz, Diflovidazine, Diflubenzuron, dimpropyridaz, Dinactin, Dinocap, Dinotefuran, Dioxabenzofos, Emamectin, Empenthrin, Epsilon-momfluorothrin, Epsilon-metofluthrin, Esfenvalerate, Ethion, Ethiprole, Etofenprox, Etoxazole, Famphur, Fenazaquin, Fenfluthrin, Fenitrothion, Fenobucarb, Fenothiocarb, Fenoxycarb, Fenpropathrin, Fenpyroxymate, Fensulfothion, Fenthion, Fentinacetate, Fenvalerate, Fipronil, Flometoquin, Flonicamid, Fluacrypyrim, Fluazaindolizine, Fluazuron, Flubendiamide, Flubenzimine, Flucitrinate, Flucycloxuron, Flucythrinate, Fluensulfone, Flufenerim, Flufenprox, Flufiprole, Fluhexafon, Flumethrin, Fluopyram, Flupyradifurone, Flupyrimin, Fluralaner, Flupentiofenox, Fluvalinate, Fluxametamide, Fosthiazate, Gamma-Cyhalothrin, Gossyplure™, Guadipyr, Halofenozide, Halofenozide, Halofenprox, Heptafluthrin, Hexythiazox, Hydramethylnon, Imicyafos, Imidacloprid, Imiprothrin, Indoxacarb, lodomethane, Iprodione, Isocycloseram, Isothioate, Ivermectin, Kappa-bifenthrin, Kappa-tefluthrin, Lambda-Cyhalothrin, Lepimectin, Lufenuron, Metaflumizone, Metaldehyde, Metam, Methomyl, Methoxyfenozide, Metofluthrin, Metolcarb, Mexacarbate, Milbemectin, Momfluorothrin, nicofluprole Niclosamide, Nitenpyram, Nithiazine, Omethoate, Oxamyl, Oxazosulfyl, Parathion-ethyl, Permethrin, Phenothrin, Phosphocarb, Piperonylbutoxide, Pirimicarb, Pirimiphos-ethyl, Polyhedrosis virus, Prallethrin, Profenofos, Profenofos, Profluthrin, Propargite, Propetamphos, Propoxur, Prothiophos, Protrifenbute, Pyflubumide, Pymetrozine, Pyraclofos, Pyrafluprole, Pyridaben, Pyridalyl, Pyrifluquinazon, Pyrimidifen, Pyrimostrobin, Pyriprole, Pyriproxyfen, Resmethrin, Sarolaner, Selamectin, Silafluofen, Spinetoram, Spinosad, Spirodiclofen, Spiromesifen, Spirotetramat, Sulfoxaflor, Tebufenozide, Tebufenpyrad, Tebupirimiphos, Tefluthrin, Temephos, Tetrachloraniliprole, Tetradiphon, Tetramethrin, Tetramethylfluthrin, Tetranactin, Tetraniliprole, Theta-cypermethrin, Thiacloprid, Thiamethoxam, Thiocyclam, Thiodicarb, Thiofanox, Thiometon, Thiosultap, Tioxazafen, Tolfenpyrad, Toxaphene, Tralomethrin, Transfluthrin, Triazamate, Triazophos, Trichlorfon, Trichloronate, Trichlorphon, Triflumezopyrim, Tyclopyrazoflor, Zeta-Cypermethrin.

The pesticidal compositions of the present invention may be prepared according to standard procedures known in the art.

As already indicated, the pesticidal compositions of the present invention have, for practical purposes, a very advantageous level of activity in controlling insect pests in crops of useful plants after foliar or soil application, whilst also maintaining acceptable crop safety (phytotoxicity) outcomes. Further, the compositions of the present invention when in an agrochemical formulation may possess any number of other benefits compared to other compositions including, inter alia, the prevention of sedimentation, thickening, phase separation, cloudiness, foaming or crystal growth, chemical stability of the spiropidion active ingredient (degradation), long-term formulation stability (eg, at high temperature, such as 45° C.), or reduced clogging of spray nozzles during application and spray drift.

### EXAMPLES

The Examples which follow serve to illustrate the invention, and in particular, demonstrate the formulation stablisation benefits of the use of a dispersing agent in accordance with the present invention (ie, Atlox™ 4913) against a polyalkylene glycol ether dispersant system known in the art, ie, ATLAS™ G-5000D (Croda, UK). Table 1 (below) describes the components of a composition D (as a suspension concentrate) according to the invention and a composition C (as a suspension concentrate), which is not according to the invention.

TABLE 1

| | | Composition D | Composition C |
|---|---|---|---|
| Component* | | (% by weight) | (% by weight) |
| Spiropidion | active ingredient | 9.5 | 9.6 |
| Abamectin | active ingredient | 1.4 | 1.4 |
| Acrylic graft copolymer solution in | dispersing agent | 3.0 | 0.2 |
| water and propylene glycol. | (Atlox ™ 4913) | | |
| Sodium alkyl naphthalene sulfonate | dispersing agent | 0.4 | — |
| formaldehyde condensate. | (Morwet ™ D-425) | | |
| Non-ionic polyalkylene glycol ether. | dispersing agent | — | 1.0 |
| | (ATLAS ™ G-5000D) | | |
| 1,2-propylene glycol. | anti-freeze agent | 7.6 | 5.1 |
| Montmorillonite-type clay. | thickening agent | 1.9 | 2.4 |
| | (Bentopharm ™ 20) | | |

*Other components making up compositions D and C relate to minor amounts (less than 0.25% by weight per component) of commercially-available formulation inert materials such as anti-foaming agent, buffering agent, wetting agent, suspension agent, preservative (biocide) and thickening agent.

The remainder of the compositions D and C are made up to 100% by weight with water. Compositions D and C are prepared according to routine methods.

Storage at −10/10° C. cycling (low temperature) for 8 weeks of compositions D and C resulted in the flocculation of active ingredient particles in the suspension concentrate compositions for composition C and not for composition D, thus resulting in a failure for composition C at low temperature.

Additionally, storage at 40° C. (high temperature) for 8 weeks of compositions D and C showed evidence of crystal growth of active ingredient particles in the suspension concentrate compositions for composition C and not for composition D, again resulting in a failure for composition C at high temperature.

Flocculation and crystal growth behaviours of the compositions D and C were assessed using conventional microscopy and/or particle size measurement techniques.

1. A pesticidal composition comprising:
(i) 5 to 15% by weight of spiropidion;
(ii) 1 to 5% by weight of abamectin; and
(iii) 1 to 5% by weight of a dispersing agent comprising an acrylic graft copolymer solution in water and propylene glycol.

2. The pesticidal composition according to claim 1, comprising:
(i) 8 to 10% by weight of spiropidion; and
(ii) 1 to 2% by weight of abamectin.

3. The pesticidal composition according to claim 1, wherein the acrylic graft copolymer is 2-propenoic acid, 2-methyl-, polymer with methyl 2-methyl-2-propenoate, ester with a-methyl-w-hydroxypoly (oxy-1,2-ethanediyl), graft.

4. The pesticidal composition according to claim 1, comprising a further dispersing agent as 0.2 to 1.0% by weight of a sodium alkyl naphthalene sulfonate formaldehyde condensate.

5. The pesticidal composition according to claim 1, further comprising 5 to 10% by weight of 1,2-propylene glycol.

6. The pesticidal composition according to claim 1, comprising 0.1 to 2% by weight of a thickening agent selected from a natural gum substance, or a montmorillonite clay.

7. The composition according to claim 1, further comprising one or more additional ingredients selected from an anti-freeze agent, an anti-foam agent, a thickening agent, a biocide (preservative), a buffering agent, a stabilizer and/or a pigment.

8. The pesticidal composition according to claim 1, wherein the composition is a suspension concentrate.

9. An aqueous composition comprising the pesticidal composition according to claim 1, optionally further comprising one or more adjuvants or carriers, wherein the weight ratio of spiropidion to abamectin is 7:1 to 5:1.

10. The aqueous composition according to claim 9, wherein the adjuvant is selected from a mineral oil, a vegetable oil, an esterified vegetable oil, a methylated vegetable oil or an alkyl ester phosphate-based adjuvant, and preferably, an alkyl ester phosphate-based adjuvant.

11. A method of combating and controlling pests which comprises applying to a pest, to a locus of a pest, or to a crop of a useful plant susceptible to attack by a pest, a composition according to claim 9.

12. The method according to claim 11, wherein the pest is selected from the order Homoptera, Thysanoptera, Acarina or Lepidoptera.

13. The method according to claim 11 , wherein the pest is selected from white flies, mites, aphids, thrips.

14. The method according to claim 11, wherein the plant is a perennial plant selected from citrus or tea, or the plant is selected from the order Cucurbitaceae, the order Solanaceae or the order Malvaceae.

15. The method according to claim 11, wherein the plant is selected from tea, cucumber, melon, watermelon, citrus, strawberry, eggplant, tomato, pepper, chili, okra.
